(19) United States
(12) Patent Application Publication
(10) Pub. No.: US 2026/0199175 A1
(43) Pub. Date: Jul. 16, 2026

(54) MASSAGE CHAIR

(71) Applicant: LG ELECTRONICS INC., Seoul (KR)

(72) Inventors: Hyungkyu YOUK, Seoul (KR); Bohyun KIM, Seoul (KR)

(73) Assignee: LG ELECTRONICS INC., Seoul (KR)

(21) Appl. No.: 19/136,072

(22) PCT Filed: May 16, 2024
(86) PCT No.: PCT/KR2024/006629

§ 371 Date: Jun. 5, 2025

(30) Foreign Application Priority Data
May 15, 2023 (KR) 10-2023-0062398

(51) Int. Cl. A61H 7/00; A61H 15/00; A61H 23/00; A61H 23/02

(52) U.S. Cl. CPC A61H 7/007; A61H 15/0078; A61H 23/006; A61H 23/0254; A61H 2015/0028; A61H 2201/0149; A61H 2201/0192; A61H 2201/1215; A61H 2201/149; A61H 2201/1609; A61H 2201/1669; A61H 2201/1678

(57) ABSTRACT

Disclosed is a massage chair, including: a first arm provided with a first massage ball; a second arm provided with a second massage ball and rotatably coupled to the first arm; and a connecting portion connecting the first arm and the second arm to each other and configured to adjust a spacing distance between the first massage ball and the second massage ball while eccentrically rotating with respect to the first arm.

### TECHNICAL FIELD

The present disclosure relates to a massage chair.

### BACKGROUND ART

Recently, there are increasing demand on relieving muscles in the knot or addressing fatigue and stress through the massage at home, and the interest on the massage apparatus is soaring. The massage is one among medical supplementary therapies which help circulation of the blood and relief of fatigue by brushing, kneading, pressing, pulling, tapping, or moving the human body using hands, or a specially made apparatus.

An apparatus configured to perform the massage through a mechanical device is referred to as a massage apparatus, and the most representative example of the massage apparatus is a massage chair such as the massage chair on which a user can sit comfortably and receive the massage.

The massage chair has various functions such as tapping, rubbing, rolling, acupressure, reclining, and leg massaging so as to address tone of the muscles and mental fatigue.

However, there was a problem in the conventional massage chair in that the effect of the massage has been dramatically fallen compared to that performed by a massager because the movement of a massage ball of the conventional massage chair is not similar to that of the massager.

Regarding this problem, as the prior art, a massage apparatus is disclosed in the Korean Patent No. 10-0704351.

The prior art literature consists of a first arm in which a first massage head is mounted, a second arm in which a second massage head is mounted, a drive device configured to rotate the first arm and the second arm so that a distance between the first massage head and the second massage head can be changed, and a pressing portion configured to generate a pressing force in a direction of allowing a massage head mounted in one among the first arm and the second arm to advance.

However, in the prior art literature, there is a problem in that the overall manufacturing cost increases because an additional driving source such as an air pump must be installed so as to rotate the first arm and the second arm, and an elastic air-bag must be installed in the pressing portion so as to press the first arm, or the second arm.

### DISCLOSURE

### Technical Problem

The present disclosure is conceived to solve the problem of the conventional massage chair described above, and the object of the present disclosure is to provide the user who sits on the massage chair with a similar feeling to that of receiving actual massage from the massager by implementing the movement of the massage ball to be similar to the movement of the massager.

In addition, the object of the present disclosure is to allow the massage chair to implement a similar movement to a movement of the massager which is curling and uncurling a thumb and the rest of the fingers in the implementation of the movement of the massage ball for massaging the body of the user.

### Technical Solution

One embodiment is a massage chair, including: a first arm provided with a first massage ball; a second arm provided with a second massage ball and rotatably coupled to the first arm; and a connecting portion connecting the first arm and the second arm to each other and configured to adjust a spacing distance between the first massage ball and the second massage ball while eccentrically rotating with respect to the first arm.

The massage chair may further include: a first axis disposed on one side of the first arm and configured to rotatably couple the second arm to the first arm; a second axis configured to rotatably couple one side of the connecting portion to the second arm; a third axis disposed on another side of the first arm; and an eccentric axis allowing another side of the connecting portion to be rotatably coupled thereto and rotated eccentrically with respect to the third axis.

The first axis may be disposed between the first massage ball and the third axis.

The second axis may be disposed between the second massage ball and the first axis.

A distance from the third axis to the first massage ball may be farther than a distance from the third axis to the second massage ball.

The first axis may be disposed between the second massage ball and the second axis.

The third axis may be disposed between the first massage ball and the first axis.

A distance from the second axis to the second massage ball may be farther than a distance from the second axis to the first massage ball.

The massage chair may further include: a first axis disposed on one side of the first arm and configured to rotatably couple one side of the second arm to the first arm; a second axis disposed on another side of the second arm; a third axis disposed on another side of the first arm; a first eccentric axis allowing one side of the connecting portion to be rotatably coupled thereto and rotated eccentrically with respect to the second axis; and a second eccentric axis allowing another side of the connecting portion to be rotatably coupled thereto and rotated eccentrically with respect to the third axis.

### Advantageous Effect

According to the massage chair according to the present disclosure, there is an effect that a spacing distance between the first arm and the second arm can be adjusted because the connecting portion eccentrically rotated with respect to the first arm rotates the second arm with respect to the first arm.

In addition, the massage chair according to the present disclosure has an effect that the massage chair may implement a similar movement to a movement of the massager which is curling and uncurling a thumb and the rest of the fingers because the spacing distance between the first arm and the second arm can be adjusted due to the structure of the connecting portion.

The effects of the present disclosure are not limited to the above-described effects and other effects which are not described herein may be clearly understood by those skilled in the art from the following description of the embodiments of the present disclosure.

### DESCRIPTION OF DRAWINGS

FIG. 1 is a front view of a massage chair according to an embodiment of the present disclosure.

FIG. 2 is a view schematically illustrating a drive device of a back massage portion according to an embodiment of the present disclosure.

FIG. 3 is a view illustrating a vertical and horizontal movement of a massage ball according to an embodiment of the present disclosure.

FIG. 4 is a perspective view of a massage unit according to an embodiment of the present disclosure.

FIG. 5 is a side view of a massage unit according to an embodiment of the present disclosure.

FIGS. 6 and 7 are enlarged views of a massage unit according to an embodiment of the present disclosure.

### MODE FOR DISCLOSURE

Hereinafter, exemplary embodiments of the present disclosure will be described in further detail with reference to the accompanying drawings.

The present disclosure may be modified variably and may have various embodiments, particular ones of which will be illustrated in drawings and described in detail. However, it should be understood that the following exemplifying description of the disclosure is not meant to restrict the disclosure to specific forms of the present disclosure but rather the present disclosure is meant to cover all modifications, similarities and alternatives which are included in the spirit and scope of the present disclosure.

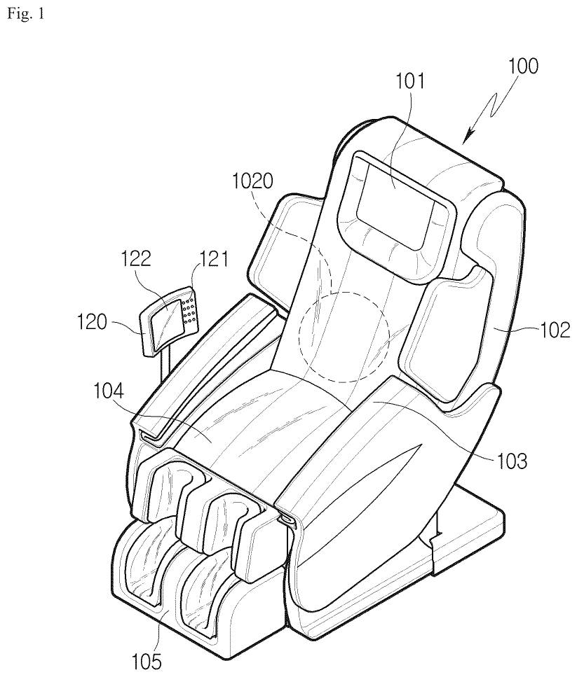

FIG. 1 is a front view of a massage chair according to an embodiment of the present disclosure.

A massage chair 100 according to the present embodiment may provide firsthand mechanical stimulation to a body of the user who sits on the massage chair by tapping, pressing, kneading, pulling, or making the body of the user move according to an operation mode. The massage chair 100 may massage one or more among a head, a back, arms, a hip, and legs of the user who sits on the massage chair. Such a massage chair may be provided indoor, for example, at home.

The massage chair 100 may include a main body driven to provide massage to the user. The main body is provided such that the body of the user can be sat thereon, and may be divided into an upper portion, a sitting portion, and a lower portion according to a position in which the body is sat. That is, the massage chair 100 may provide comfortableness and restfulness because it consists of the upper portion in a shape of surrounding the head of the user, the sitting portion in a shape in which an upper body of the user can lean and sit, and the lower portion in a shape of surrounding calves and feet. At this instance, a size and a position of each portion of the massage chair 100 may be changed automatically or manually to fit for the characteristic of the body of the user.

The upper portion may include a head massage portion 101 configured to support and massage the head of the user. The sitting portion may include a back massage portion 102 configured to support and massage the back of the user, an arm massage portion 103 configured to support and massage the arm of the user, and a hip massage portion 104 configured to support and massage the hip of the user. The lower portion may include a leg massage portion 105 configured to support and massage the calves and the feet of the user.

The massage chair 100 may include a user interface portion 120. Here, the user interface portion 120 may include a manipulation part 121 configured to receive an input from the user and a display part 122 configured to display massage related information. For example, the user interface portion 120 may be configured as a touch screen form in which the manipulation part 121 and the display part 122 are integrated into one.

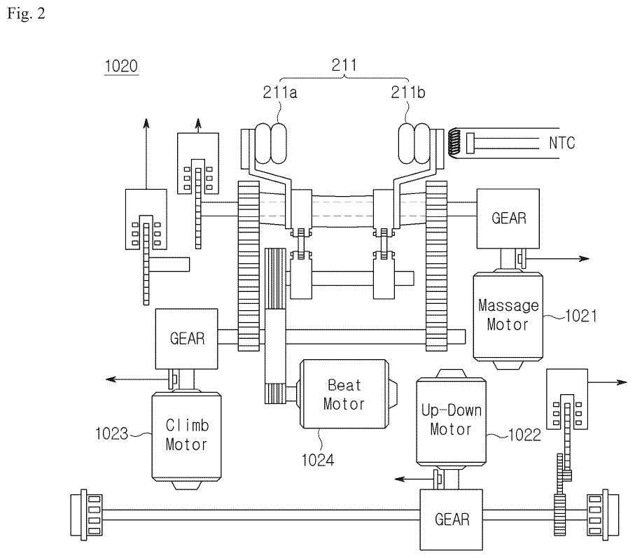

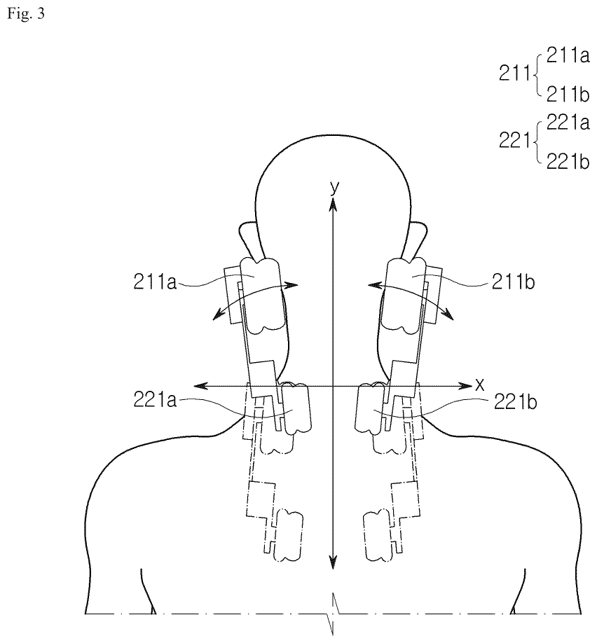

FIG. 2 is a view schematically illustrating a drive device of the back massage portion according to an embodiment of the present disclosure, and FIG. 3 is a view illustrating a vertical and horizontal movement of a massage ball according to an embodiment of the present disclosure.

A drive device 1020 of the back massage portion 102 (hereinafter referred to as ‘the drive device’) may control a movement of a massage unit 200 which will be described below.

The massage unit 200 may include massage balls 211 and 221. The massage balls 211 and 221 are configured to perform operations of tapping and/or pulling and pushing (a kneading operation) a back portion of the user, and may be disposed on a right side and a left side.

The massage balls 211 and 221 may operate by receiving power generated when a first motor 1021 which will be described below rotates. For example, the massage balls 211a and 221a disposed on the left and massage balls 211b and 221b on the right may be connected to each other through a cam shaft, and may reciprocate (a transverse axis movement) in left and right directions such that the left and right massage balls 211a, 211b, 221a, and 221b repeat coming into close contact with each other and then growing apart from each other as the cam shaft rotates when the first motor 1021 rotates. At this instance, the cam shaft may mean a third axis A3 which will be described below. Alternatively, the cam shaft may rotate with the third axis A3 in coaxial connection with the third axis A3.

Each of the left massage balls 211a and 211b, and the right massage balls 221a and 221b may be rotatably coupled to each of left arms 210a and 220a, and right arms 210b and 220b, respectively. The arms 210a, 210b, 220a and 220b are a frame extending in a vertical direction and may consist of the left arms 210a and 220a coupled to the left massage balls 211a and 221a, and the right arms 210b and 220b coupled to the right massage balls 211b and 221b. The massage balls 211a, 211b, 221a and 221b may be rotatably coupled to an upper portion of each of the arms 210a, 210b, 220a and 220b. In addition, the cam shaft is coupled to lower sides of the first arms 210a and 210b on the left and right sides so that the first arms 210a and 210b on the left and right sides can be connected to each other.

The drive device 1020 may further include a first motor 1021.

As described above, with the rotary operation of the first motor 1021, the massage balls 211 and 221 may move in the left and right directions (in an x axis direction in FIG. 3). For example, a gear part consisting of a worm and a worm gear is provided between the first motor 1021 and the cam shaft and the gear part may serve to deliver the power for rotation of the first motor 1021 to the cam shaft. In more retail, the left massage balls 211a and 221a and the right massage balls 211b and 221b may repeat coming into close contact with each other and then growing apart from each other as each of them move in left and right directions. For example, each of the left massage balls 211a and 221a and the right massage balls 211b and 221b may be provided one and/or two in number.

The drive device 1020 may further include a second motor 1022.

With the rotary operation of the second motor 1022, the massage balls 211 and 221 may move in the vertical direction (in a y axis direction in FIG. 3). For example, the back massage portion 102 may have a rail extending in a vertical direction on each of the left side and the right side. At this instance, a movement axis configured to move vertically along the rail while connecting the rails in a transverse direction may be provided. The movement axis may be directly or indirectly connected to the arms 210 and 220 of the massage balls 211 and 221.

The movement axis may be moved vertically by receiving the power for rotation from the second motor 1022, and accordingly, the massage balls 211 and 221 may move vertically.

A gear part consisting of one or more gears so as to switch over a size and/or a direction of the power may be further provided between the second motor 1022 and the movement axis.

The drive device 1020 may further include a third motor 1023.

With the rotary operation of the third motor 1023, the massage balls 211 and 221 may move in the forward and rearward directions. The third motor 1023 may make the arms 210 and 220 to which the massage balls 211 and 221 are provided move in the forward and rearward directions, and as a result, the massage balls 211 and 221 may move in the forward and rearward directions. Therefore, when the massage balls 211 and 221 move in the forward and rearward directions by the operation of the third motor 1023, a kneading force may be applied to the body of the user who sits on the massage chair 100.

A gear part consisting of one or more gears so as to switch over a size and/or a direction of the power may be further provided between the third motor 1023 and the arms 210 and 220. In a possible embodiment, the gear part for the movement of the massage balls 211 and 221 in the forward and rearward directions may be configured to include a fan-shaped sector gear. However, this is merely an example, and the shape of the gear is not limited thereto.

The drive device 1020 may further include a fourth motor 1024.

With the rotary operation of the fourth motor 1024, the massage balls 211 and 221 may reciprocate fast in the forward and rearward directions. The fourth motor 1024 may move the arms 210 and 220 of the massage balls 211 and 221 in the forward and rearward directions, and as a result, the massage balls 211 and 221 may move in the forward and rearward directions. That is, when the massage balls 211 and 221 reciprocate in the forward and rearward directions by the operation of the fourth motor 1024, a tapping force may be applied to the body of the user who sits on the massage chair 100.

A gear part consisting of one or more gears so as to switch over a size and/or a direction of the power may be further provided between the fourth motor 1024 and the arms 210 and 220. In a possible embodiment, the gear part for the movement of the massage balls 211 and 221 in the forward and rearward directions may be configured to include a chain, or a pulley and a belt. However, this is merely an example, and the shape of the gear is not limited thereto.

The drive device 1020 may further include a control unit (not illustrated).

The control unit is configured to control an operation of one or more motors included in the drive device 2010, and may control an operation of each motor based on a preset data.

In addition, upon start of the operation of the massage chair 100, the control unit may move the massage balls 211 and 221 vertically and horizontally or in the forward and rearward directions by controlling operations of the first to fourth motors 1021, 1022, 1023 and 1024 for a predetermined time period.

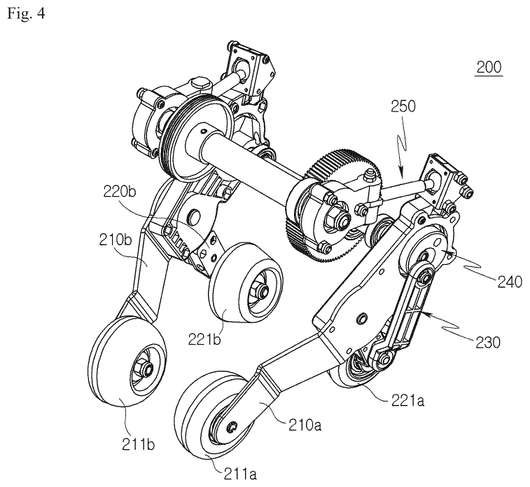

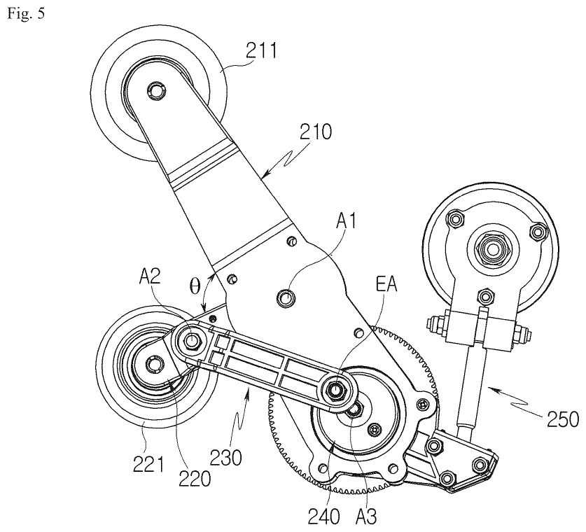

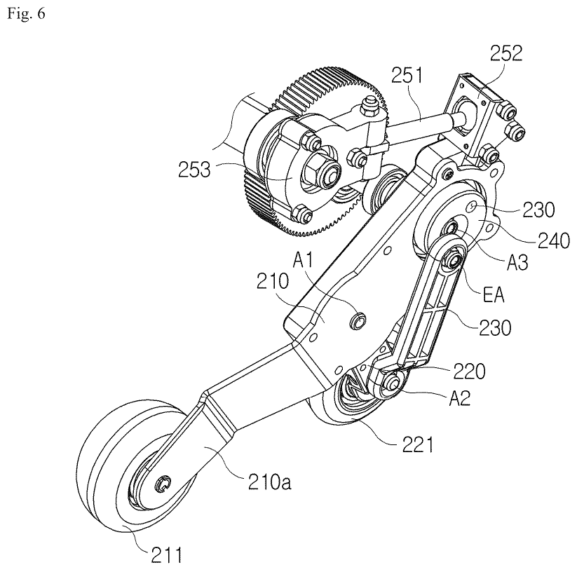

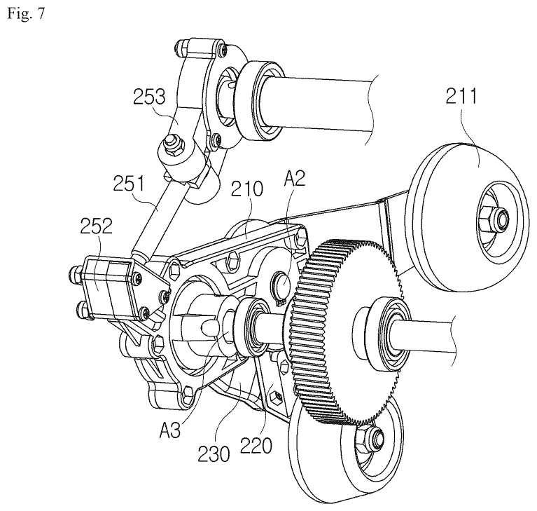

FIG. 4 is a perspective view of a massage unit according to an embodiment of the present disclosure, FIG. 5 is a side view of the massage unit according to an embodiment of the present disclosure, and FIGS. 6 and 7 are enlarged views of the massage unit according to an embodiment of the present disclosure.

Hereinafter, referring to FIGS. 4 to 7, the massage unit of the massage chair according to an embodiment of the present disclosure will be described.

The massage chair according to an embodiment of the present disclosure may include the massage unit 200. The massage unit 200 is configured to implement operations of tapping and/or pulling and pushing (a kneading operation) a back portion of the user, and may include the first arm 210, the second arm 220, and the connecting portion 230.

The first massage ball 211 may be provided to the first arm 210. The first arm 210 may operate by receiving power generated when the first motor 2021 which will be described below rotates.

As an embodiment, the first arm 210 may include the first arm 210a on the left and the first arm 210b on the right. The first massage ball 211a on the left may be provided on the first arm 210a on the left, and the first massage ball 211b on the right may be provided on the first arm 210b on the right. The first arm 210a on the left and the first arm 210b on the right may be connected to each other through the cam shaft. The first arms 210a and 210b may be rotatably coupled to the cam shaft, or fixed to the cam shaft. At this instance, the cam shaft may mean the third axis A3 which will be described below, alternatively, the cam shaft and the third axis A3 may be in coaxial connection with each other and may rotate together. A reciprocating motion (a transverse axis movement) in left and right directions may be performed such that the first arm 210a on the left and the first arm 210b on the right repeat coming into close contact with each other and then growing apart from each other as the cam shaft rotates when the first motor 1021 rotates.

The first arm 210 may be coupled to a support portion 250. The support portion 250 may include a connection link 251 and a fixing member 253. A lower side of the first arm may be coupled to the connection link 251. The connection link 251 may support a movement of the first arm 210 when the first arm 210 is shaken in the left and right directions as the first motor 1021 operates. A lower end of the connection link may be formed in a ball shape. The lower end of the connection link 251 may be inserted into the coupling member 252 provided in a lower end of the first arm 210. An upper end of the connection link may be rotatably coupled to the fixing member 253. Therefore, when the first arm 210 is shaken in the left and right directions, the fixing member 253 may be fixed.

The second arm 220 may be rotatably coupled to the first arm 210. The second arm 220 may be rotatably coupled to the first arm 210 through a first axis A1. The second massage ball 221 may be provided in the second arm 220.

As an embodiment, the second arm 220 may include the second arm 220a on the left and the second arm 220b on the right. The second arm 220a on the left may be rotatably coupled to the first arm 220b on the left, and the second arm 220b on the right may be rotatably coupled to the first arm 210b on the right. The second massage ball 221a on the left may be provided on the second arm 220a on the left, and the second massage ball 221b on the right may be provided on the second arm 220b on the right.

The connecting portion 230 may connect the first arm 210 and the second arm 220 to each other. The connecting portion 230 may adjust a spacing distance between the first massage ball 211 and the second massage ball 221 while rotating eccentrically with respect to the first arm 210.

As an embodiment, one side of the connecting portion 230 may be rotatably coupled to a second axis A2, and another side of the connecting portion 230 may be rotatably coupled to an eccentric axis EA. The eccentric axis EA may be rotated eccentrically with respect to the third axis A3.

A rotating part 240 may be rotatably coupled to the first arm. The rotating part 240 may be rotatably coupled about the third axis A3.

The eccentric axis EA may be coupled to the rotating part 240. The eccentric axis EA may be fixed to the rotating part 240 in a state in which the eccentric axis EA is parallel to the third axis A3. The eccentric axis EA may be rotatably inserted into a groove 240a formed in the rotating part 240 in a state in which the eccentric axis EA is parallel to the third axis A3. The eccentric axis EA may orbit about the third axis A3 in a state in which the eccentric axis EA is coupled to the rotating part 240. The eccentric axis EA may eccentrically rotate with respect to the third axis A3 because the rotating part 240 rotates about the third axis A3. Therefore, the connecting portion 230 may eccentrically rotate with respect to the third axis A3 while rotating about the eccentric axis EA.

When the connecting portion 230 eccentrically rotates with respect to the third axis A3, the second arm 220 may rotate about the first axis A1. Therefore, as an angle θ between the first arm 210 and the second arm 220 changes, the spacing distance between the first arm 210 and the second arm 220 may be adjusted.

Hereinafter, a plurality of axes connecting the first arm 210, the second arm 220, and the connecting portion 230 in the massage chair according to an embodiment of the present disclosure will be described in detail.

The axes according to an embodiment of the present disclosure may consist of the first axis A1, the second axis A2, the third axis A3, and the eccentric axis EA. The first axis A1, the second axis A2, the third axis A3, and the eccentric axis EA may be disposed in parallel to one another.

The first axis A1 may be disposed on one side of the first arm 210. The first axis A1 may rotatably connect one side of the second arm 220 to the first arm 210.

The second axis A2 may be disposed on another side of the second arm 220. The second axis A2 may rotatably connect one side of the connecting portion 230 to the second arm 220.

The third axis A3 may be disposed on another side of the first arm 210. The third axis A3 may be connected to the cam shaft which delivers power so that the first arm 210 is rotated or moved in left and right directions. Alternatively, the third axis A3 may mean a portion of the cam shaft.

The eccentric axis EA may be disposed on another side of the connecting portion 230. The eccentric axis EA may rotatably connect the another side of the connecting portion 230 to the first arm 210. The eccentric axis EA may eccentrically rotate with respect to the third axis A3. Therefore, when the eccentric axis EA eccentrically rotates with respect to the third axis A3, the connecting portion 230 may eccentrically rotate with respect to the third axis A3.

For example, the second axis A2 may rotatably connect the connecting portion 230 to the second arm 220. The connecting portion 230 may be rotatably coupled to the second arm 220 about the second axis A2. Therefore, the one side of the connecting portion 230 may rotate about the second axis A2, and the another side of the connecting portion 230 may eccentrically rotate with respect to the third axis A3 while rotating about the eccentric axis EA.

However, as another example, the connecting portion 230 may eccentrically rotate with respect to the second axis A2 and the third axis A3. That is, a rotating axis connecting the second arm 220 and the connecting portion 230 (hereinafter, a first eccentric axis) may be eccentrically disposed with respect to the second axis A2, and a rotating axis connecting the first arm 210 and the connecting portion 230 (hereinafter, a second eccentric axis) may be eccentrically disposed with respect to the third axis A3. In addition, the one side of the connecting portion 230 may be rotatably coupled to the first eccentric axis, and the another side of the connecting portion 230 may be rotatably coupled to the second eccentric axis. Therefore, the one side of the connecting portion 230 may eccentrically rotate with respect to the second axis A2 while rotating about the first eccentric axis, and the another side of the connecting portion 230 may eccentrically rotate with respect to the third axis A3 while rotating about the second eccentric axis.

Meanwhile, in the massage chair according to an embodiment of the present disclosure, the one side of the second arm 220 is rotatably coupled to a center portion of the first arm 210, and thus, the connecting portion 230 may be rotatably coupled about the second axis A2 thereto, and may eccentrically rotate with respect to the third axis A3. Therefore, position relationships of the massage balls 211 and 221, and the plurality of axes A1, A2, A3, and EA may be the same as those illustrated in FIG. 5.

That is, as an example, the first axis A1 may be disposed between the first massage ball 211 and the third axis A3. In addition, the second axis A2 may be disposed between the second massage ball 221 and the first axis A2. Moreover, a distance from the third axis A3 to the first massage ball 211 may be farther than a distance from the third axis A3 to the second massage ball 221. Further, referring to FIG. 5, an imaginary linear line connecting a center of the first massage ball 211 and a center of the third axis A3 may pass a center of the first axis A1. Also, an imaginary linear line connecting a center of the second massage ball 221 and the center of the first axis A1 may pass a center of the second axis A2.

However, in the massage chair according to another embodiment of the present disclosure, the one side of the first arm 210 may be coupled to a center portion of the second arm 220.

That is, as another example, the first axis A1 may be disposed between the second massage ball 221 and the second axis A2. In addition, the third axis A3 may be disposed between the first massage ball 211 and the first axis A1. Moreover, a distance from the second axis A2 to the second massage ball 221 may be farther than a distance from the second axis A2 to the first massage ball 211. Further, an imaginary linear line connecting the center of the second massage ball 221 and the center of the second axis A2 may pass the center of the first axis A1. Also, an imaginary linear line connecting the center of the first massage ball 211 and the first axis A1 may pass the center of the third axis A3.

It is also understood by one of ordinary skill in the art that any flowcharts, flow diagrams, state transitions, pseudo codes, etc. illustrated in the present disclosure, may be substantially embodied in a computer-readable medium as various processes that may be carried out by a computer or processor, whether or not the computer or the processor is explicitly shown.

Accordingly, the aforementioned embodiments can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), etc.

The functions of various elements illustrated in the drawings may be related to appropriate software, and be provided via not only hardware capable of executing the software but also exclusive hardware. These functions may also be provided via a single exclusive processor, a single shared processor, or a plurality of individual processors, some of which may be shared.

Also, explicit use of the term ‘processor’ or ‘controller’ is not limited to exclusively using hardware capable of executing software, and may implicitly include a digital signal processor (DSP) hardware, and a read-only memory (ROM), a random access memory (RAM), or a non-volatile storage medium for storing software.

While the exemplary embodiments have been particularly shown and described with reference to the drawings, it will be understood by those of ordinary skill in the art that various changes in form and details may be made therein without departing from the spirit and scope of the inventive concept as defined by the appended claims. The exemplary embodiments should be considered in descriptive sense only and not for purposes of limitation. Therefore, the scope of the inventive concept is defined not by the described embodiments but by the appended claims.

1. A massage chair, comprising:
a first arm provided with a first massage ball;
a second arm provided with a second massage ball and rotatably coupled to the first arm; and
a connecting portion connecting the first arm and the second arm to each other and configured to adjust a spacing distance between the first massage ball and the second massage ball while eccentrically rotating with respect to the first arm.

2. The massage chair of claim 1, further comprising:
a first axis disposed on one side of the first arm and configured to rotatably couple the second arm to the first arm;
a second axis configured to rotatably couple one side of the connecting portion to the second arm;
a third axis disposed on another side of the first arm; and
an eccentric axis allowing another side of the connecting portion to be rotatably coupled thereto and rotated eccentrically with respect to the third axis.

3. The massage chair of claim 2,
wherein the first axis is disposed between the first massage ball and the third axis.

4. The massage chair of claim 2,
wherein the second axis is disposed between the second massage ball and the first axis.

5. The massage chair of claim 2,
wherein a distance from the third axis to the first massage ball is farther than a distance from the third axis to the second massage ball.

6. The massage chair of claim 2,
wherein the first axis is disposed between the second massage ball and the second axis.

7. The massage chair of claim 2,
wherein the third axis is disposed between the first massage ball and the first axis.

8. The massage chair of claim 2,
wherein a distance from the second axis to the second massage ball is farther than a distance from the second axis to the first massage ball.

9. The massage chair of claim 1, further comprising:
a first axis disposed on one side of the first arm and configured to rotatably couple one side of the second arm to the first arm;
a second axis disposed on another side of the second arm;
a third axis disposed on another side of the first arm;
a first eccentric axis allowing one side of the connecting portion to be rotatably coupled thereto and rotated eccentrically with respect to the second axis; and
a second eccentric axis allowing another side of the connecting portion to be rotatably coupled thereto and rotated eccentrically with respect to the third axis.
